(19) United States
(12) Patent Application Publication
(10) Pub. No.: US 2004/0163212 A1
(43) Pub. Date: Aug. 26, 2004

(54) Hinge

(76) Inventor: Herbert Isele, Lustenau (AT)

Correspondence Address: WENDEROTH, LIND & PONACK, L.L.P., 2033 K STREET N. W., SUITE 800, WASHINGTON, DC, 20006-1021, US

(21) Appl. No.: 10/395,108

(22) Filed: Mar. 25, 2003

(30) Foreign Application Priority Data
Feb. 21, 2003 (AT) GM 108/2003

(51) Int. Cl. E05D 7/04

(52) U.S. Cl. 16/235

(57) ABSTRACT

A hinge (2) for furniture with a frame (3) and with a door wing (1) secured to the frame (3). The hinge (2) has a bedplate (5) to be fitted to the frame (3), which bedplate carries a hinge arm (7), and a joint-adjustment screw (24). The hinge arm (7) is housed directly on the bedplate (5), the bedplate (5) and the hinge arm (7) being connected to each other by a common axle (22). Furthermore, the hinge arm (7) is able to be tilted relative to the bedplate (5) by means of the joint-adjustment screw (24) which is held in the hinge arm (7). The hinge arm (7) is able to be moved in the direction of the depth of the item of furniture by means of an eccentric (37) or a spiral disk (29).

### BACKGROUND OF THE INVENTION

The invention relates to a hinge for furniture with a frame and with a door wing secured to the frame, with a bedplate which is to be fitted to the frame and which carries a hinge arm, and with a joint-adjustment screw.

In modern furniture construction, so-called door frames are sometimes used, these frames, as a stable part of the item of furniture, carrying the hinges for a door wing. The actual side walls of the body of the furniture are made from weaker material. This brings with it the advantage that either the overall costs of the item of furniture can be reduced, or higher-quality and thus optically more attractive materials can be chosen for the side walls without the furniture thereby becoming substantially more expensive.

Such a hinge is known for example from the Austrian utility model AT 1385 U1.

### SUMMARY OF THE INVENTION

The object of the invention is to improve a hinge of this type such that a simple adjustment of the hinge arm and thus of the door wing in three dimensions is possible without an additional intermediate piece having to be provided at the hinge.

The object according to the invention is achieved in that the hinge arm is housed directly on the bedplate, the bedplate and the hinge arm being connected to each other by a common axle, and the hinge arm being able to be tilted relative to the bedplate by means of the joint-adjustment screw and able to be moved in the direction of the depth of the item of furniture by means of an eccentric.

### BRIEF DESCRIPTION OF THE DRAWINGS

Two embodiments of the invention are described below with reference to the figures of the attached drawings. There are shown in:

FIG. 1 a perspective view of a hinge according to the invention in mounting position, wherein sections of the frame and of the door wing are shown;

FIG. 2 an exploded perspective view of a hinge according to the invention;

FIG. 3 a top view of a hinge according to the invention;

FIG. 4 a section along the line A-A of FIG. 3;

FIG. 5 the cut-out section A of FIG. 4;

FIG. 6 a perspective view of another embodiment of a hinge according to the invention in mounting position, wherein sections of the frame and of the door wing are shown;

FIG. 7 an exploded perspective view of a hinge according to the embodiment of FIG. 6;

FIG. 8 a side view of a hinge according to the invention, wherein sections of the frame and of the door wing are shown;

FIG. 9 a section along the line A-A of FIG. 8;

FIG. 10 the cut-out section A of FIG. 9;

FIG. 11 a side view of a hinge according to the invention after joint adjustment has taken place;

FIG. 12 a section along the line A-A of FIG. 11;

FIG. 13 the cut-out section A of FIG. 12;

FIG. 14 a top view of a hinge according to the invention;

FIG. 15 a section along the line A-A of FIG. 14; and

FIG. 16 the cut-out section A of FIG. 15.

### DETAILED DESCRIPTION OF THE PREFERRED EMBODIMENTS

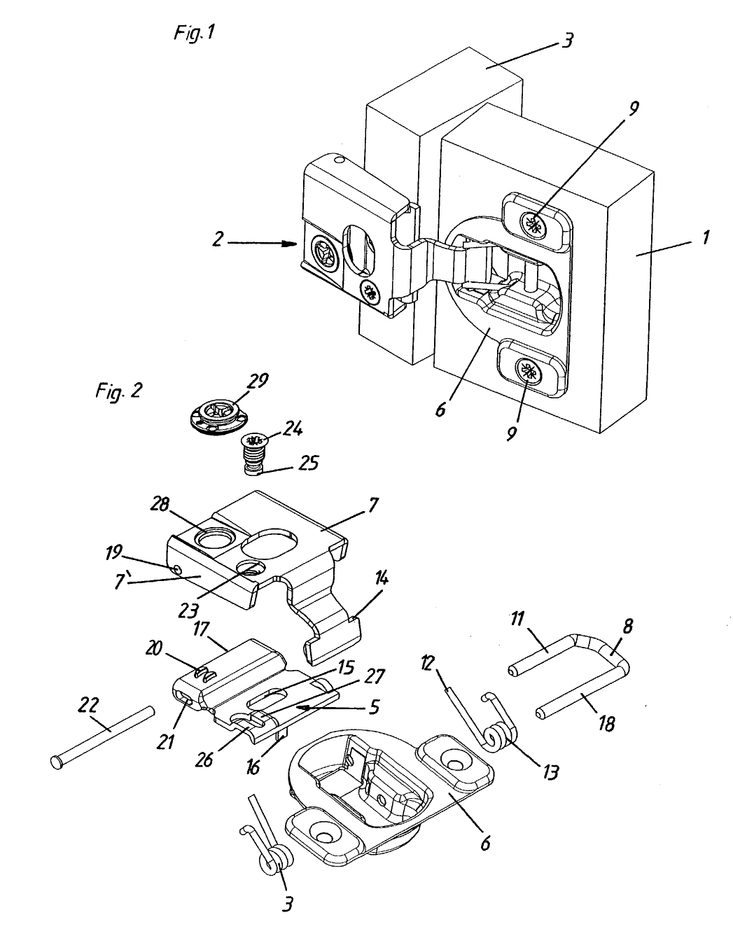

In FIG. 1, the door wing 1 is shown in the open position. The hinge 2 connects the door wing 1 to the frame 3 of the body of the item of furniture.

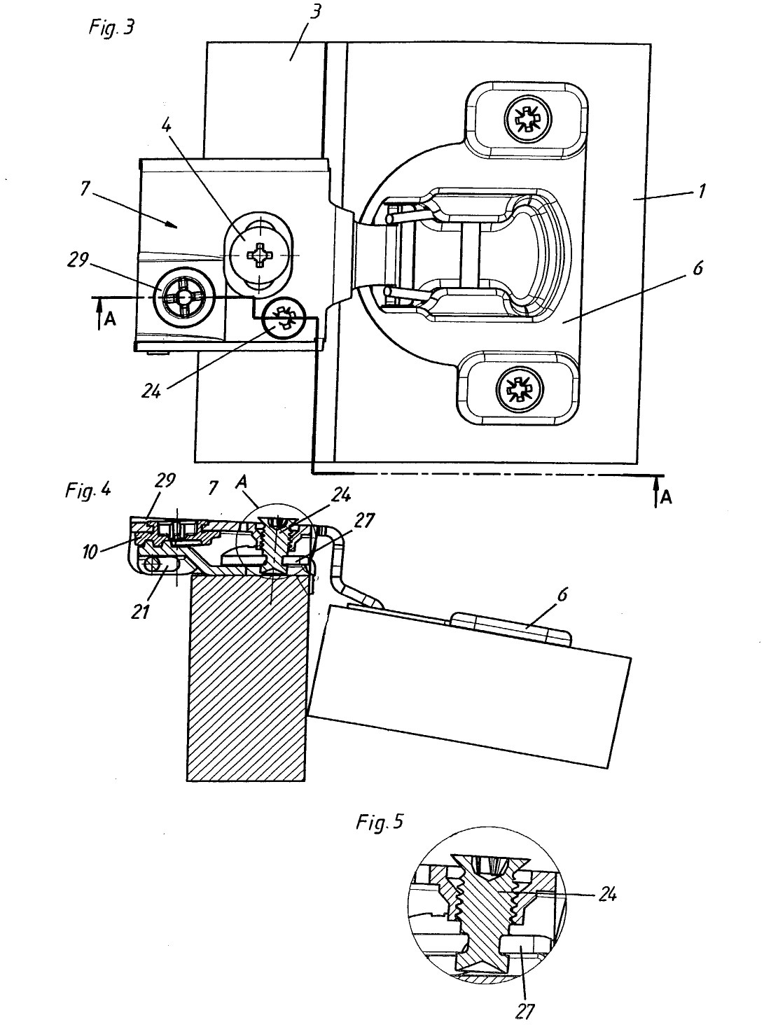

According to the embodiment of FIGS. 1 to 5, the hinge 2 consists of the bedplate 5, the hinge arm 7 and the hinge casing 6 on the door wing side. The hinge arm 7 is housed on the bedplate 5. The hinge casing 6 is articulated to the hinge arm 7 by means of a hinge axle. The hinge axle is formed by one leg 11 of a U-stirrup 8.

The hinge casing 6 is inserted into a bore in the door wing 1 in mounting position and screwed to the door wing 1 by means of screws 9.

Two legged springs 13, which exert a closure force, are housed at the hinge casing 6. The legged springs 13 are housed on the second leg 18 of the U-stirrup 8.

The legs 12 of the legged springs 13 press on a control part 14 which is developed at the free end of the hinge arm 7. The hinge casing 6 is held in the closure position by the legged springs 13, or pulled into the closure position if the angle between the door wing 1 and the closure plane is very small.

The bedplate 5 is housed directly against the frame 3 and is screwed to the frame 3 by means of a screw 4 which projects through an oblong hole 15 of the bedplate 5. On the side facing the door wing 1, the bedplate 5 has an angled projection 16 which rests against the frame 3 at the front in mounting position.

At the rear of the frame 3, the bedplate 5 is provided with a base 17. The hinge arm 7 is developed with U-shaped cross-section, the side bars 7′ of the hinge arm 7 pointing towards the bedplate 5. The side bars 7′ of the hinge arm 7 have holes 19 which are designed as bores or punched holes. The side walls of the base 17 of the bedplate 5 have oblong holes 21. The hinge arm 7 is articulated to the bedplate 5 by means of an axle 22 which projects through the holes 19, 21.

The hinge arm 7 is also provided with a nut thread 23 in which a joint-adjustment screw 24 is housed. The joint-adjustment screw 24 engages with its head 25 behind a stirrup 26 punched out from the bedplate 5, said screw projecting through an oblong hole 27, open to the rear, in the stirrup 26.

A spiral disk 29 is housed in a rear opening 28 of the hinge arm 7. The spiral projection 10 of the spiral disk 29 lies against tooth-like projections 20 of the bedplate 5 in mounting position. The projections 20 are developed at the base 17 of the bedplate 5.

If the position of the door wing 1 is to be adjusted in the direction of the furniture joint, the joint-adjustment screw 24 is turned and thus the hinge arm 7 is tilted about the axle 22.

In order to adjust the position of the door wing 1 in the direction of the depth of the item of furniture, a turning of the spiral disk 29 is sufficient. In the process, the hinge arm 7 can be moved over the length of the oblong holes 21.

The height setting of the door wing 1 takes place by loosening of the fixing screw 4 projecting through the oblong hole 15 and then moving of the whole hinge 2, the fixing screw 4 being tightened again once height positioning has taken place.

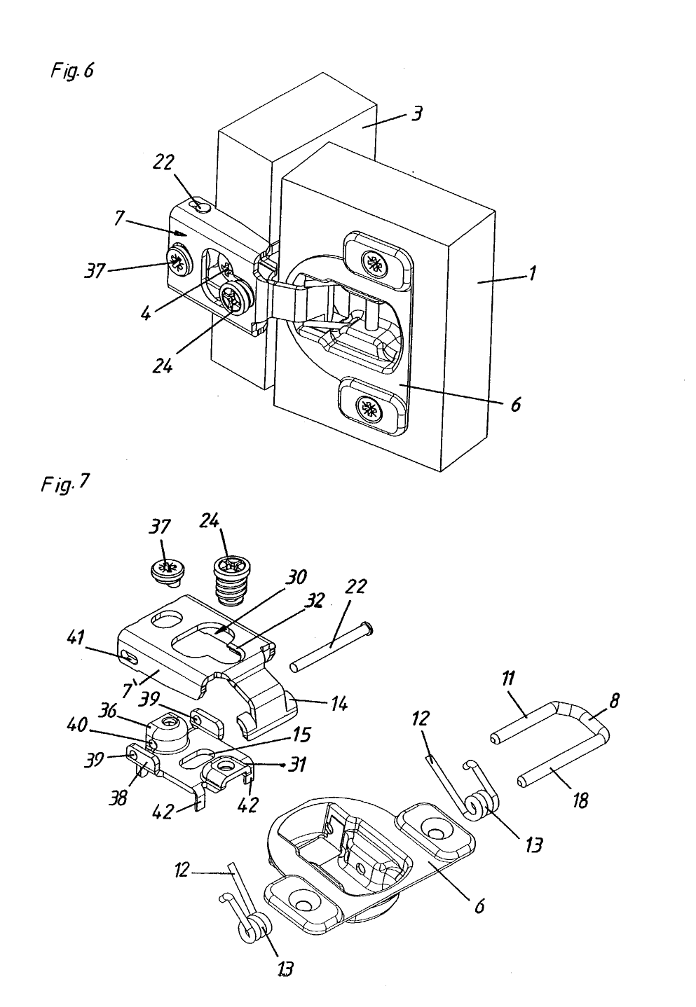

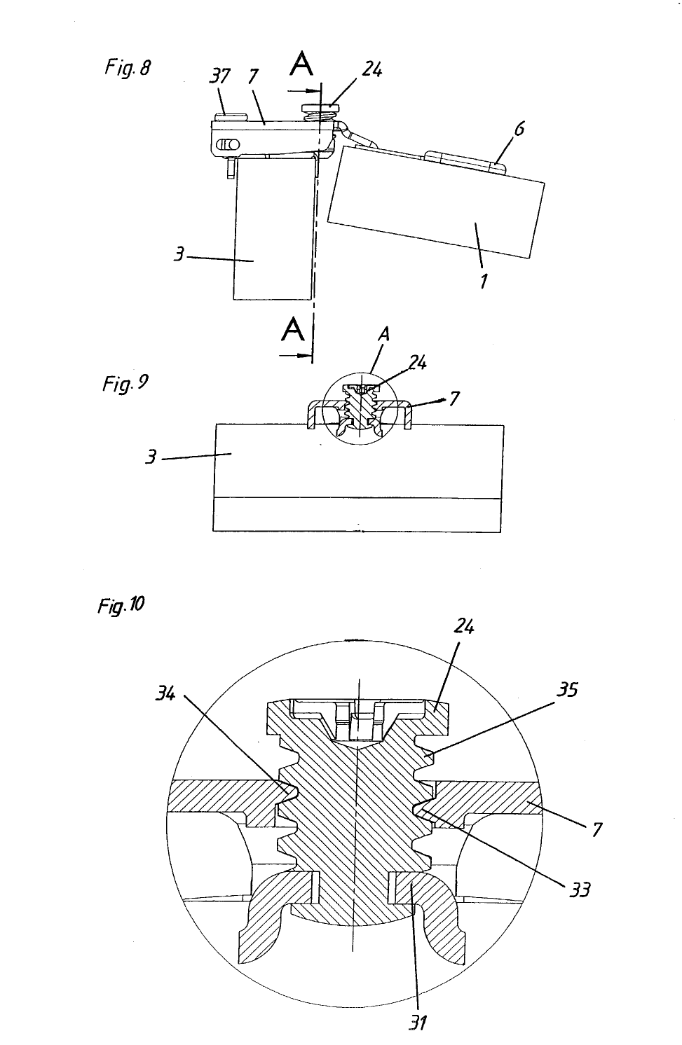

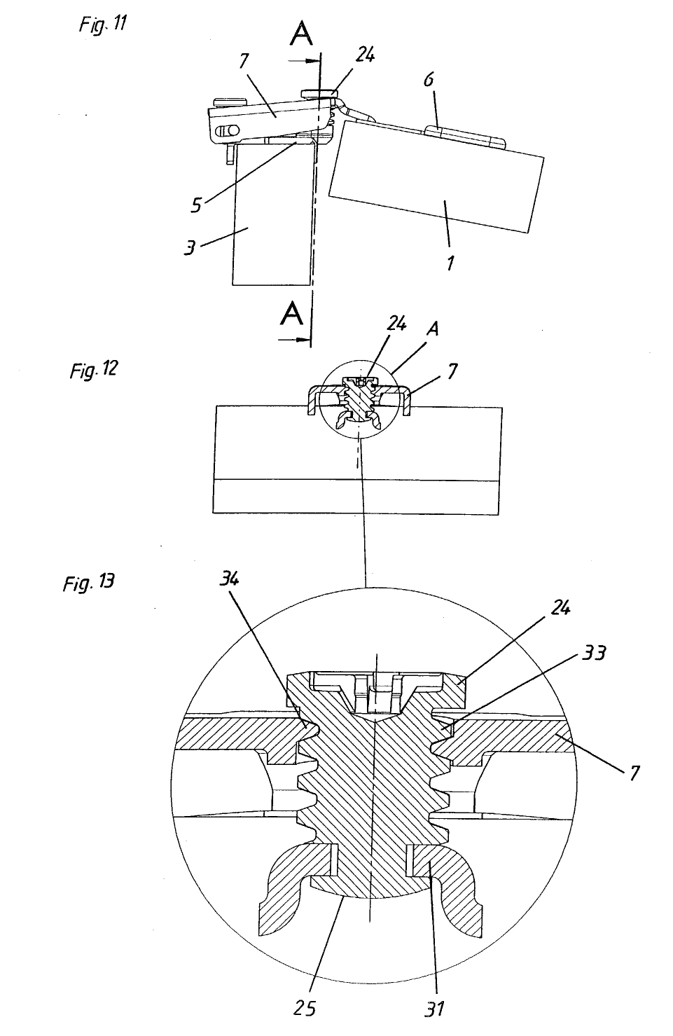

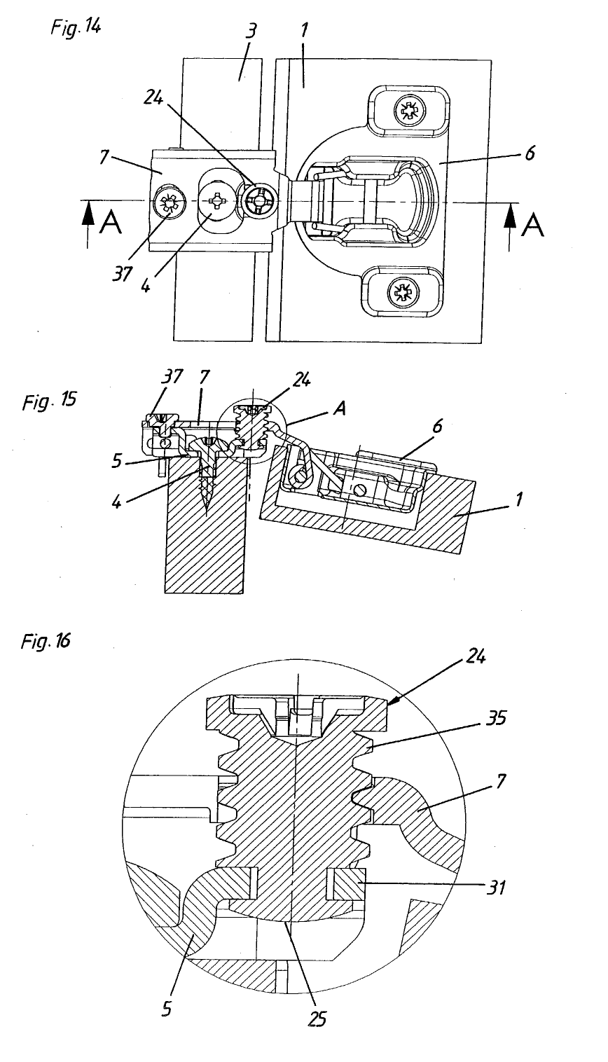

In the embodiment according to FIGS. 6 to 16, the hinge 2 again consists of a bedplate 5, a hinge arm 7 and a hinge casing 6. The hinge casing 6 is again articulated to the hinge arm 7 by means of an axle which is formed by one leg 11 of a stirrup 8. Springs 13 which are housed on the second leg 18 of the stirrup 8 press with their legs on a control part 14 at the free end of the hinge arm 7. This structure corresponds to the previous embodiment.

The hinge arm 7 has a keyhole 30 and the bedplate 5 a stirrup 31 in which the head 25 of the joint-adjustment screw 24 is riveted. The threaded section of the joint-adjustment screw 24 projects through an oblong hole 32, open to the rear, which forms the narrower section of the keyhole 30.

The opposite-facing rims 33, 34 of the oblong hole 32 engage in the thread 35 of the joint-adjustment screw 24. In order to facilitate this, the rims 33, 34 are offset relative to each other in the longitudinal direction of the joint-adjustment screw 24.

In the rear region of the bedplate 5, a base 36 is again provided in which this time an eccentric 37 is housed. The bedplate 5 has side bars 38 angled upwards, i.e. in the direction of the hinge arm 7, in which side bars holes 39 are provided. The holes 39 are aligned with holes 40 in the base 36.

The side bars 7′ of the hinge arm 7 are provided with oblong holes 41.

An axle 22 projects through the holes 39, 40 and through the oblong holes 41 and thus connects the hinge arm 7 to the bedplate 5.

The bedplate 5 has angled bars 42 at the front which rest against the front of the frame 3 in mounting position.

The adjustment of the hinge 2 takes place as in the case of the previously described embodiment. If the position of the door wing 1 is to be adjusted in the direction of the furniture door joint, the joint-adjustment screw 24 is turned and the hinge arm 7 is thus tilted about the axle 22.

In order to adjust the position of the door wing 1 in the direction of the depth of the item of furniture, a turning of the eccentric 37 is sufficient. In the process, the hinge arm 7 can be moved by the length of the oblong holes 41 in its side bars 7′.

The height setting of the door wing 1 again takes place by loosening of the fixing screw 4 projecting through the oblong hole 15 and then moving of the whole hinge 2, the fixing screw 4 being tightened again once height positioning has taken place.

1. Hinge for furniture with a frame and with a door wing secured to the frame, with a bedplate to be fitted to the frame, which bedplate carries a hinge arm, and with a joint-adjustment screw, characterized in that the hinge arm is housed directly on the bedplate, the bedplate and the hinge arm being connected to each other by a common axle, and the hinge arm being able to be tilted relative to the bedplate by means of the joint-adjustment screw and able to be moved in the direction of the depth of the item of furniture by means of an eccentric.

2. Hinge according to claim 1, characterized in that the eccentric is developed as a spiral disk.

3. Hinge according to claim 1, characterized in that the common axle of the hinge arm and of the bedplate and the axis of rotation of the eccentric lie in one plane.

4. Hinge according to claim 1, characterized in that the eccentric is housed in the bedplate.

5. Hinge according to claim 1, characterized in that the eccentric is housed in a base through which the common axle of the hinge arm and of the bedplate projects.

6. Hinge according to claim 1, characterized in that the axle projects through oblong holes in the hinge arm.

7. Hinge according to claim 1, characterized in that the axle projects through oblong holes in the bedplate.

8. Hinge according to claim 6, characterized in that the axle projects through round holes in the bedplate and through oblong holes in the hinge arm.

9. Hinge according to claim 1, characterized in that the joint-adjustment screw is anchored with its head in the bedplate and projects through an oblong hole in the hinge arm, the opposite-facing rims of the oblong hole engaging in the thread of the joint-adjustment screw.

10. Hinge according to claim 9, characterized in that the opposite-facing rims of the oblong hole which engage in the thread of the joint-adjustment screw are offset relative to each other in the longitudinal direction of the joint-adjustment screw.

11. Hinge according to claim 1, characterized in that the joint-adjustment screw is riveted in the bedplate.

12. Hinge according to claim 9, characterized in that the oblong hole is designed as part of a keyhole.

13. Hinge according to claim 2, characterized in that the spiral disk is housed in the hinge arm and rests with a spiral projection against at least one projection of the bedplate.

14. Hinge according to claim 1, characterized in that the joint-adjustment screw and the spiral disk are arranged laterally offset relative to a central plane of the hinge arm which is aligned perpendicular to the axis of rotation of the hinge.

15. Hinge according to claim 1, characterized in that the joint-adjustment screw is housed in a nut thread of the hinge arm.

16. Hinge according to claim 1, characterized in that the bedplate has an oblong hole for receiving a fixing screw, which hole is aligned vertically in mounting position of the bedplate.

17. Hinge according to claim 1, characterized in that the hinge is developed as a single-axle hinge.
